(19) United States
(12) Patent Application Publication
(10) Pub. No.: US 2014/0304419 A1
(43) Pub. Date: Oct. 9, 2014

(54) SYSTEM AND TERMINAL FOR P2P CONNECTION IN MOBILE ENVIRONMENT AND METHOD FOR P2P CONNECTION USING THE SAME

(71) Applicant: SAMSUNG SDS CO., LTD., Seoul (KR)

(72) Inventors: Hee-Tae YOON, Seoul (KR); Jung-Hwan MOON, Seoul (KR); Doo-Jin RYU, Seoul (KR)

(73) Assignee: SAMSUNG SDS CO., LTD., Seoul (KR)

(21) Appl. No.: 14/011,964

(22) Filed: Aug. 28, 2013

(30) Foreign Application Priority Data
Apr. 5, 2013 (KR) 10-2013-0037293

(51) Int. Cl. H04L 29/08

(52) U.S. Cl. CPC H04L 67/104
USPC 709/228

(57) ABSTRACT

A method for peer-to-peer (P2P) connection in a mobile environment, the method comprising: transmitting, from a first peer to a second peer, a connection request message through a push mechanism; transmitting, from the second peer to the first peer, a connection response message including connection information containing a private address of the second peer, a public address of the second peer and an address of a relay server; and attempting, at the first peer, to connect with the second peer by making a first connection attempt using the private address of the second peer, a second connection attempt using the public address of the second peer, and a third connection attempt using the address of the relay server, the first to the third connection attempts being made concurrently or sequentially at predetermined time intervals.

### CROSS-REFERENCE TO RELATED APPLICATION

This application claims priority to and the benefit of Republic of Korea Patent Application No. 10-2013-0037293, filed on Apr. 5, 2013, the disclosure of which is incorporated herein by reference in its entirety.

### BACKGROUND

1. Field

Embodiments of the present disclosure relate to a P2P connection system, terminal, and method, and more particularly, to a mobile environment P2P system in which a P2P connection request message is transmitted via a push message in a mobile environment so that an attempt at a P2P connection may be made only when the P2P connection is needed.

2. Discussion of Related Art

Peer-to-peer (P2P) technology allows the sharing of music files, document files, and video files, as well as the sharing of a database (DB), a central processing unit (CPU), and so on, in one's own computer, over the Internet. P2P has been popularized by file sharing services that allow individuals connected to the Internet to share their music files or video files, and to download files they desire. According to the P2P technology, information is provided, retrieved and downloaded from a peer, such as a computer or the like, connected to a network in a horizontal peer-to-peer manner, rather than a vertical approach of using a search engine, etc., to retrieve information on the Internet.

Recently, as smartphone sales have boomed, P2P services are becoming increasingly used over network connections in a mobile environment (mobile P2P). However, since mobile network information (e.g., a private address, a public address, a network address translation (NAT) type, and so on) is frequently subject to change, in accordance with changes in the mobile environment, it is inconvenient to register or update every change in network information at the relevant server or servers.

If the network information is changed, in accordance with change in the mobile environment, a user terminal has to obtain, by carrying out a STUN test, information regarding a type of NAT for the network to which the user terminal is connected, and must register information in the server about the user terminal's private address, public address, and NAT type.

In addition, when the user terminal needs to persistently communicate with the server for such things as the maintenance of network information changed in the mobile environment, the resulting increase in power consumption of the user terminal is problematic because mobile user terminals have only limited power reserves.

### SUMMARY

One or more exemplary embodiments may overcome the above disadvantage and/or other disadvantages not described above. However, it is understood that one or more exemplary embodiment are not required to overcome the disadvantage described above, and may not overcome any of the problems described above.

The present disclosure is directed to transmission of a P2P connection request message via a push message in a mobile environment so that a user terminal may attempt P2P connection only when the P2P connection is needed and, accordingly, conserve power.

Further, the present disclosure is directed to facilitating P2P connections without needing a STUN Test to obtain NAT type information, so that the time required to make a P2P connection can be decreased.

According to an exemplary embodiment, there is provided a method, intended for use in peer-to-peer (P2P) connection in a mobile environment, the method including: transmitting, from a first peer to a second peer, a connection request message through a push mechanism; transmitting, from the second peer to the first peer, a connection response message including connection information containing: a private address of the second peer, a public address of the second peer, and an address of a relay server; and making, at the first peer, one or more of first to third connection attempts to connect with the second peer, the first to third connection attempts including: a first connection attempt using the private address of the second peer, a second connection attempt using the public address of the second peer, and a third connection attempt using the address of the relay server; wherein the first to third connection attempts are carried out using one of: a concurrent manner, and a sequential manner, at predetermined time intervals.

In another exemplary embodiment, after making the one or more of the first to third connection attempts, the first peer connects with the second peer through a given one of the first to third connection attempts before connecting with the second peer through either of the others of the first to third connection attempts.

In yet another exemplary embodiment, the first connection attempt includes: transmitting a first channel generation request message from the first peer to the second peer via the private address of the second peer; and transmitting a first channel generation response message in response to the first channel generation request message from the second peer to the first peer via a private address of the first peer.

According to another exemplary embodiment, the second connection attempt includes: transmitting a hole generation message from the first peer to the second peer, and generating a first peer-side hole so that the first peer is enabled to directly receive data transmitted from the second peer; transmitting, from the first peer to the second peer, through the relay server, a second channel generation request message for a second connection between the first peer and the second peer; and transmitting, from the second peer to the first peer, a second channel generation response message, in response to the second channel generation request message, and generating a second peer-side hole such that the second peer is enabled to directly receive data transmitted from the first peer.

In another exemplary embodiment, making the third connection attempt includes: transmitting a third channel generation request message, from the first peer to the second peer through the relay server; and transmitting a third channel generation response message in response to the third channel generation request message from the second peer to the first peer through relay server.

In yet another exemplary embodiment, a system for peer-to-peer (P2P) connection in a mobile environment includes a connection server configured to: receive a connection request message from a first peer; transmit the connection request message to a push server; receive, from a second peer, a connection response message including connection information containing: a private address of the second peer, a public address of the second peer, and an address of a relay server; and transmit the connection response message to the first peer; the push server is configured to receive the connection request message, from the connection server, and transmit the connection request message to the second peer through a push mechanism; and the relay server is configured to maintain a user datagram protocol (UDP) connection with the first peer and the second peer.

According to another exemplary embodiment, a system for peer-to-peer (P2P) connection in a mobile environment includes: a relay server configured to: maintain a user datagram protocol (UDP) connection with a first peer and a second peer; receive a connection request message from the first peer; transmit the connection request message to a push server; receive, from the second peer, a connection response message including connection information containing: a private address of the second peer, a public address of the second peer, and an address of the relay server; and transmit the connection response message to the first peer; and the push server configured to receive the connection request message, from the relay server, and transmit the connection request message to the second peer through a push mechanism.

In another exemplary embodiment, a terminal for peer-to-peer (P2P) connection in a mobile environment includes: a transmitter, and a receiver; the receiver being configured to receive, from a connection server or a relay server, a connection response message including connection information containing: a private address of another terminal, a public address of the other terminal, and an address of the relay server; the transmitter being configured to attempt to connect with the other terminal by making first to third connection attempts including: a first connection attempt using the private address of the other terminal, a second connection attempt using the public address of the other terminal, and a third connection attempt using the address of the relay server; and the first to third connection attempts being carried out using one of: a concurrent manner, and a sequential manner, at predetermined time intervals.

According to yet another exemplary embodiment, the terminal connects with the other terminal through a given one of the first to third connection attempts before connecting with the other terminal through either of the others of the first to third connection attempts.

### BRIEF DESCRIPTION OF THE DRAWINGS

The above and other objects, features and advantages of the exemplary embodiments of the present disclosure will become more apparent to those skilled in the art from the following detailed description when taken in conjunction with the accompanying drawings, in which:

FIG. 1 schematically shows a P2P connection system according to an exemplary embodiment of the present disclosure;

FIG. 2 is a flowchart for illustrating a P2P connection method according to an exemplary embodiment of the present disclosure;

FIG. 3 illustrates connection information used in a network for a peer according to an exemplary embodiment of the present disclosure;

FIG. 4 is a flowchart illustrating a process of forming a channel for a first P2P connection using a private address of a peer according to an exemplary embodiment of the present disclosure;

FIG. 5 is a flowchart illustrating a process of forming a channel for a second P2P connection using a public address of a peer according to an exemplary embodiment of the present disclosure; and

FIG. 6 is a flowchart illustrating a process of forming a channel for a third P2P connection using an address of a relay server according to an exemplary embodiment of the present disclosure.

### DETAILED DESCRIPTION OF EXEMPLARY EMBODIMENTS

Exemplary embodiments of the present disclosure will be described in detail below with reference to the accompanying drawings. While the present disclosure is described with reference to exemplary embodiments thereof, it will be apparent to those skilled in the art that various modifications can be made without departing from the spirit and scope of the present disclosure.

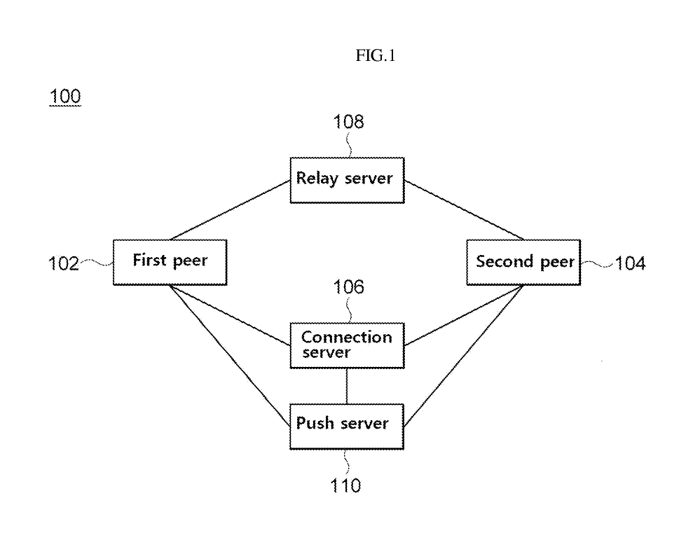

FIG. 1 schematically shows a P2P connection system according to an exemplary embodiment of the present disclosure.

First, it should be noted that the examples below are discussed in the context of UDP implementations in a mobile environment, rather than a context in which a P2P connection uses a relay server based on TCP, while UDP is blocked.

In FIG. 1, a P2P connection system 100 according to an exemplary embodiment of the present disclosure includes a first peer 102, a second peer 104, a connection server 106, a relay server 108, and a push server 110.

Referring to FIG. 1, it is assumed that the first peer 102 requests a connection to the second peer 104 by transmitting a connection request message to the second peer 104.

The first peer 102 and the second peer 104, when connected in a P2P manner, exchange data. Each of the first peer 102 and the second peer 104 can be a device which may transmit packets over a network. Such a device may be, for example, a cellular phone, a smartphone, a tablet PC, a PDA, and the like. The first peer 102 and the second peer 104 may be in the same private network, or may be in private networks with different NAT types. Such networks include Wi-Fi networks, mobile communication networks (e.g., 3G or LTE), WiMAX networks, and so on. It depends upon the given mobile environment to which the first peer 102 and the second peer 104 connect.

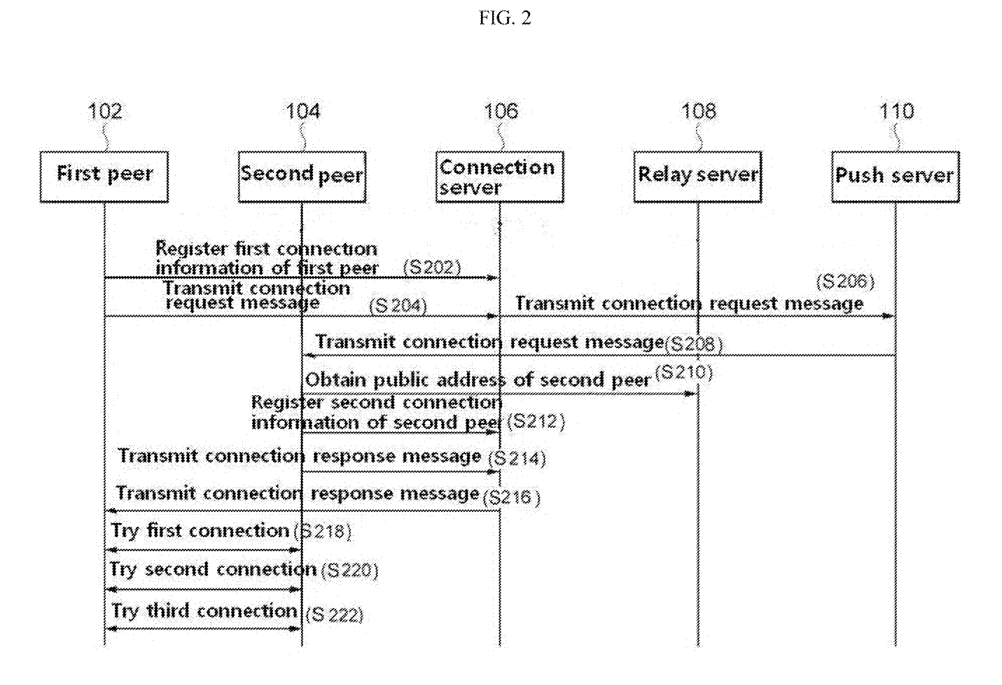

The connection server 106 registers terminal information for the P2P connection between the first peer 102 and the second peer 104, and relays a connection request message and a connection response message. The terminal information, the connection request message, and the connection response message may be relayed as described below with reference to FIG. 2.

The relay server 108 maintains a UDP connection with the first peer 102 and the second peer 104, and the first peer 102 and the second peer 104 may obtain their respective public addresses through the relay server 108. Further, the first peer 102 and the second peer 104 may generate a channel for their P2P connection through the relay server 108. How the public addresses are obtained and how the channel is generated are both described below with respect to FIGS. 2-6.

In addition to the foregoing, according to another exemplary embodiment, the relay server 108 may carry out the registering of the terminal information of the first peer 102, and terminal information of the second peer 104, and may also carry out the relaying of the connection request message and the connection response message. In such an arrangement, the use of connection server 106 is obviated.

The push server 110 transmits, to the second peer 104, the connection request message from the first peer 102. According to exemplary embodiments of the present disclosure, the first peer 102 transmits the connection request message to the second peer 104 through a push mechanism (such as push server 110) only when the first peer 102 is required to connect to the second peer 104 in a P2P manner, so that the need for the first peer 102 and the second peer 104 to consistently maintain a P2P connection can be avoided, and, accordingly, power use in the user terminals is therefore avoided. The transmission of the connection request message will be described below with reference to FIG. 2.

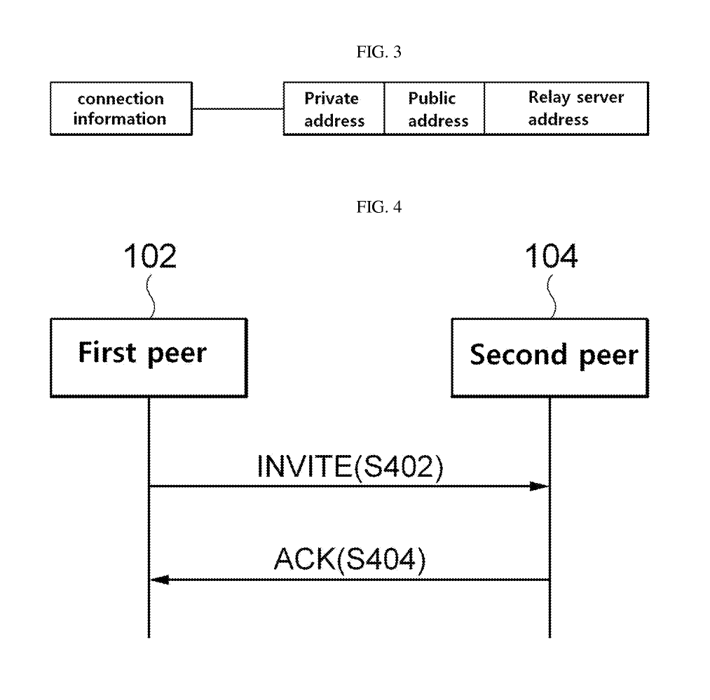

FIG. 2 is a flowchart for illustrating a P2P connection method according to an exemplary embodiment of the present disclosure. FIG. 3 depicts an example of network connection information, for a peer, according to an exemplary embodiment.

In FIG. 2, the first peer 102 registers terminal information of the first peer 102 in the connection server 106 (S202). The terminal information of the first peer 102 includes identification information, for example, a serial number, an ID/password, a telephone number, etc. In addition, as described above, according to another exemplary embodiment of the present disclosure, the first peer 102 may register the terminal information of the first peer 102 in the relay server 108.

In FIG. 2, the first peer 102 transmits the connection request message, for requesting the P2P connection, to the second peer 104 (S204). The connection server 106 transmits the connection request message to the push server 110 (S206). The push server 110 transmits the connection request message to the second peer 104 (S208).

As described below, since (a) the first peer 102 may receive the connection response message, including the connection information of the second peer 104, and (b) the first peer 102 may attempt to connect to the second peer 104 using the connection address, the connection information of the first peer 102 may not be included in the connection request message.

The connection request message is transmitted from the first peer 102, to the second peer 104, through (or via) the connection server 106 and the push server 110, using a push mechanism. Thus, according to an exemplary embodiment of the present disclosure, the separate push server 110 is employed such that the connection request message is transmitted to the second peer 104, in accordance with the push mechanism, only when the first peer 102 requests a P2P connection with the second peer 104. In such a case, the second peer 104 may transmit its own connection information to the first peer 102 in response to the connection request message.

As a result, the first peer 102 and the second peer 104 may not need to consistently maintain P2P connection between each other, and, accordingly, may avoid power consumption. In addition, as described above, according to another exemplary embodiment of the present disclosure, the relay server 108 may receive the connection request message from the first peer 102 without the connection server 106, and may receive the connection response message, including the connection information, from the second peer 104 and transmit the connection response message to the first peer 102.

When the second peer 104 receives the connection request message from the first peer 102, the second peer 104 obtains, from the relay server 108, a public address of the second peer 104 in a network (S210). When the second peer 104 maintains the UDP connection with the relay server 108, and registers a registration packet (including the private address of the second peer 104) in the relay server 108, the relay server 108 analyzes the registration packet to extract the public address of the second peer 104 and transmits the extracted public address, of the second peer 104, to the second peer 104. The private address of the second peer 104 means private IP/PORT information, and the public address of the second peer 104 means public IP/PORT information. Thus, since the second peer 104, like the first peer 102, does not carry out a STUN Test, the second peer 104 does not require information regarding the NAT type of the network to which the second peer 104 is currently connected.

The second peer 104 registers its terminal information in the connection server 106 (S212). The terminal information of the second peer 104 includes identification information of the second peer 104 such as, for example, a serial number, an ID/password, a telephone number, etc.

As described above, according to another exemplary embodiment of the present disclosure, the second peer 104 may register its terminal information in the relay server 108, without using the connection server 106.

The second peer 104 transmits, to the connection server 106 (S214), the connection response message, in response to the connection request message of the first peer 102 received via the push server 110. The connection information of the second peer 104 is included in the connection response message.

As shown in FIG. 3, the connection information includes the network information of the second peer 104 for communicating with the first peer 102, and the connection information in one exemplary embodiment includes a private address of the second peer 104, a public address of the second peer 104 and an address of the relay server 108. As described above, since the second peer 104 does not perform any STUN Test, like the first peer 102, NAT type information need not be included in the connection information.

The connection server 106 transmits the connection response message received from the second peer 104 to the first peer 102 (S216). Thus, the first peer 102 may obtain the connection information of the second peer 104.

When the first peer 102 obtains the connection information of the second peer 104, the first peer 102 makes a first connection attempt to the second peer 104 using the private address of the second peer 104 (S218). If the first peer 102 and the second peer 104 are located in the same private network, the first peer 102 may connect to the second peer 104 using the private address of the second peer 104. A method of attempting the first connection will be described below with reference to FIG. 4.

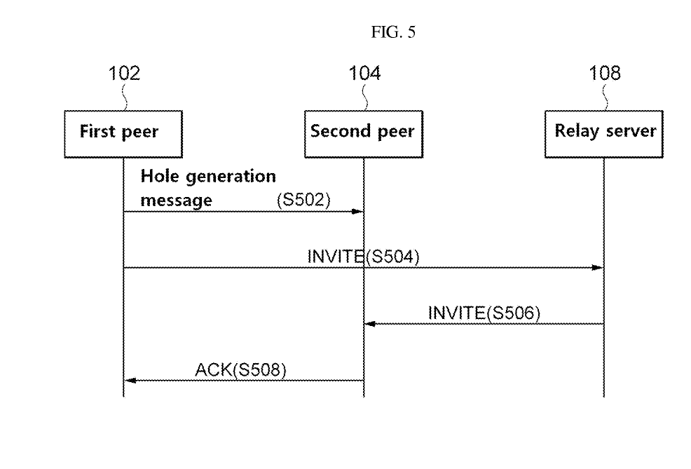

In addition, the first peer 102 makes a second connection attempt to the second peer 104 using the public address of the second peer 104 (S220). If the first peer 102 and the second peer 104 are respectively located in different private networks and the private network where one of them is located is involved with Restricted Cone NAT or Port Restricted Cone NAT, the first peer 102 may connect to the second peer 104 using the public address of the second peer 104. A method of attempting the second connection will be described below with reference to FIG. 5.

Finally, the first peer 102 makes a third connection attempt to the second peer 104 using the address of the relay server 108 (S222). If the first peer 102 and the second peer 104 are respectively located in different private networks, and both of the private networks are involved with Symmetric NAT, or one of the private networks is involved with Symmetric NAT while the other private network is involved with Port Restricted Cone NAT, then the first peer 102 can connect to the second peer 104 using the address of the relay server 108.

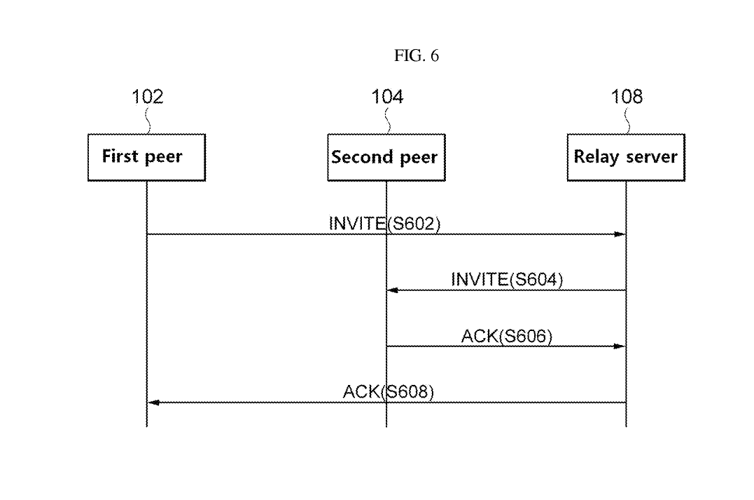

According to an exemplary embodiment of the present disclosure, the first peer 102 is allowed to connect to the second peer 104 in a P2P manner through the relay server, although otherwise the P2P connection could not be made due to their NAT types. A system according to such an exemplary embodiment provides a way so that the P2P connection between them can be achieved, no matter what the NAT types are. Further, when it is indicated by the NAT types that the first peer 102 and the second peer 104 might be connected in a P2P manner, but the P2P connection cannot be made due to all of the public addresses mapped and managed by the corresponding NAT being unavailable, the first peer 102 may still connect to the second peer 104 using the address of the relay server 108. A method of making the third connection attempt will be described in detail with reference to FIG. 6.

The first to the third types of connection attempts may be made in a concurrent manner, i.e., at the same time, or in a sequential manner at predetermined time intervals (for example, at every 100 milliseconds). Thus, according to an exemplary embodiment of the present disclosure, after the first to the third connection attempts are concurrently or sequentially made, the P2P connection may be made through one of the first to the third connection attempts before P2P connection is made through either of the others of the first to the third connection attempts.

FIG. 4 is a flowchart illustrating a process of forming a channel for a first P2P connection using a private address of a peer according to an exemplary embodiment of the present disclosure.

As described above, the first peer 102 may attempt a first connection to the second peer 104 using the private address of the second peer 104. If the first peer 102 and the second peer 104 are located in the same private network, the first peer 102 may form a channel for connection to the second peer 104.

As shown in FIG. 4, the first peer 102 transmits a channel generation request message INVITE to the second peer 104 through the private address of the second peer 104 so as to form a channel for the P2P connection to the second peer 104 (S402). The second peer 104 transmits a channel generation response message ACK to the first peer 102 using the private address of the first peer 102. The channel generation response message ACK is sent so as to accept the channel generation request represented by the channel generation request message INVITE previously transmitted from the first peer 102 (S404). Thereby, the channel for a P2P connection is formed between the first peer 102 and the second peer 104, according to an exemplary embodiment.

FIG. 5 is a flowchart illustrating a process of forming a channel for a second P2P connection using a public address of a peer, according to an exemplary embodiment of the present disclosure.

As described above, the first peer 102 may make a second kind of connection attempt to the second peer 104 using the public address of the second peer 104. If the first peer 102 and the second peer 104 are located in different private networks, and one of the private networks is involved with Restricted Cone NAT or Port Restricted Cone NAT, the first peer 102 cannot form a channel for the P2P connection to the second peer 104 using the approach described, above, with respect to the first connection attempt, but the first peer 102 may be able to form the channel for the P2P connection to the second peer 104 by making the second kind connection attempt.

In an exemplary embodiment of the present disclosure, the first peer 102 communicates with an external network using a public address of the first peer 102, and the second peer 104 communicates with an external network using a public address of the second peer 104.

As shown in FIG. 5, the first peer 102 transmits, using a public address 402 of the first peer 102, to a public address 404 of the second peer 104, a hole generation message including first peer-side hole generation instructions for forming a hole to the public address 402 of the first peer 102, without passing through the relay server 108 but directly to the second peer 104 (S502). If the second peer 104 is located in a private network involved with Restricted Cone NAT or Port Restricted Cone NAT, and if there is no record that a message has previously been transmitted from the second peer 104 to the first peer 102, the second peer-side NAT is normally set to block the first peer-side hole generation message from being transmitted to the second peer 104.

The first peer 102, however, transmits a channel generation request message INVITE not to the second peer 104 but instead to the relay server 108 (S504), and the relay server 108 in turn transfers the channel generation request message INVITE to the second peer 104 (S506). Next, since a hole is generated at the first peer's side in block 5402, the second peer 104 transfers a channel generation response message ACK, accepting the channel generation request message INVITE, through the public address 404 of the second peer 104 directly to the public address 402 of the first peer 102 without passing through the relay server 108 (S508). The second peer 104 uses the channel generation response message ACK to generate a hole to the public address 402 of the second peer 104 so as to directly receive a message transmitted from the first peer 102, which may complete the channel generation process. As such, holes are generated both on the first peer's side and on the second peer's side through use of a single UDP PORT so that a channel for the P2P connection may be formed between the first peer 102 and the second peer 104 with a hole punching process that is streamlined compared to other such processes.

FIG. 6 is a flowchart illustrating a process of forming a channel for a third P2P connection using an address of a relay server, according to an exemplary embodiment of the present disclosure.

As described above, the first peer 102 may make a third type of connection attempt to the second peer 104 using the address of the relay server 108. When the first peer 102 and the second peer 104 are located in different private networks, and both of the private networks are involved with Symmetric NAT, or one is involved with Symmetric NAT while the other is involved with Port Restricted Cone NAT, the first peer 102 cannot form a channel to make a P2P connection to the second peer 104 through the first connection attempt or the second connection attempt. However, the first peer 102 may form the channel for the P2P connection to the second peer 104 through the third connection attempt.

As shown in FIG. 6, the first peer 102 transmits a channel generation request message INVITE to the relay server 108 so as to form the channel for a P2P connection to the second peer 104 (S602). The relay server 108 transmits the channel generation request message INVITE to the second peer 104 (S604). Next, the second peer 104 transmits, to the relay server 108 (S606), a channel generation response message ACK accepting the channel generation request included in the channel generation request message INVITE transmitted from the first peer 102. The relay server 108 transmits the channel generation response message ACK to the first peer 102 (S608). As such, the channel for a P2P connection between the first peer 102 and the second peer 104 can be formed.

Generally, it takes less time for a peer to make communications with another peer using the private address of the other peer. However, in accordance with the nature and characteristics of IP-based communications, even when the peer is connectable to the other peer through the private address of the other peer, the peer may connect to the other peer using a public address of the other peer, or may connect through a relay server before the peer actually connects to the other peer using the private address of the other peer. Thus, according to an exemplary embodiment, the first peer 102 may connect to the second peer 104 through one of the first to the third connection attempts using the private address of the second peer 104, the public address of the second peer 104 and the address of the relay server 108, respectively.

According to exemplary embodiments of the present disclosure, a user terminal attempts to connect with another user terminal in a P2P manner only when the user terminal requires such a P2P connection to the other user terminal, or vice versa, so that the user terminals do not need to consistently maintain the P2P connection. Accordingly, the user terminals may thus avoid consuming power.

Further, according to exemplary embodiments of the present disclosure, the time required for making P2P connection can be decreased by skipping the STUN Test which otherwise would have to be performed whenever the network information is changed in a mobile environment.

Still further, according to exemplary embodiments of the present disclosure, a user terminal can connect to another user terminal, in a P2P manner, through a relay server, under circumstances in which otherwise the P2P connection could not have been made due to their NAT types. Thus, the P2P connection therebetween can be achieved whatever the involved NAT types are.

It will be apparent to those skilled in the art that various modifications can be made to the above-described exemplary embodiments of the present disclosure without departing from the spirit or scope of the present disclosure. Thus, it is intended that the present disclosure cover all such modifications that fall within the scope of the appended claims and their equivalents.

What is claimed is:

1. A method, intended for use in peer-to-peer (P2P) connection in a mobile environment, the method comprising:
transmitting, from a first peer to a second peer, a connection request message through a push mechanism;
transmitting, from the second peer to the first peer, a connection response message including connection information containing:
a private address of the second peer,
a public address of the second peer, and
an address of a relay server; and
making, at the first peer, one or more of first to third connection attempts to connect with the second peer, the first to third connection attempts including:
a first connection attempt using the private address of the second peer,
a second connection attempt using the public address of the second peer, and
a third connection attempt using the address of the relay server;
wherein the first to third connection attempts are carried out using one of:
a concurrent manner, and
a sequential manner, at predetermined time intervals.

2. The method of claim 1, wherein, after making the one or more of the first to third connection attempts, the first peer connects with the second peer through a given one of the first to third connection attempts before connecting with the second peer through either of the others of the first to third connection attempts.

3. The method of claim 1, wherein the first connection attempt comprises:
transmitting a first channel generation request message from the first peer to the second peer via the private address of the second peer; and
transmitting a first channel generation response message in response to the first channel generation request message from the second peer to the first peer via a private address of the first peer.

4. The method of claim 1, wherein the second connection attempt comprises:
transmitting a hole generation message from the first peer to the second peer, and generating a first peer-side hole so that the first peer is enabled to directly receive data transmitted from the second peer;
transmitting, from the first peer to the second peer, through the relay server, a second channel generation request message for a second connection between the first peer and the second peer; and
transmitting, from the second peer to the first peer, a second channel generation response message, in response to the second channel generation request message, and generating a second peer-side hole such that the second peer is enabled to directly receive data transmitted from the first peer.

5. The method of claim 1, wherein making the third connection attempt comprises:
transmitting a third channel generation request message, from the first peer to the second peer through the relay server; and
transmitting a third channel generation response message in response to the third channel generation request message from the second peer to the first peer through relay server.

6. A system for peer-to-peer (P2P) connection in a mobile environment, the system comprising:
a connection server configured to:
receive a connection request message from a first peer;
transmit the connection request message to a push server;
receive, from a second peer, a connection response message including connection information containing:
a private address of the second peer,
a public address of the second peer, and
an address of a relay server; and
transmit the connection response message to the first peer;
the push server configured to receive the connection request message, from the connection server, and transmit the connection request message to the second peer through a push mechanism; and
the relay server configured to maintain a user datagram protocol (UDP) connection with the first peer and the second peer.

7. A system for peer-to-peer (P2P) connection in a mobile environment, the system comprising:
a relay server configured to:
maintain a user datagram protocol (UDP) connection with a first peer and a second peer;
receive a connection request message from the first peer;
transmit the connection request message to a push server;
receive, from the second peer, a connection response message including connection information containing:
a private address of the second peer,
a public address of the second peer, and
an address of the relay server; and
transmit the connection response message to the first peer; and
the push server configured to receive the connection request message, from the relay server, and transmit the connection request message to the second peer through a push mechanism.

8. A terminal for peer-to-peer (P2P) connection in a mobile environment, the terminal comprising:
a transmitter, and
a receiver;
the receiver being configured to receive, from a connection server or a relay server, a connection response message including connection information containing:
a private address of another terminal,
a public address of said another terminal, and
an address of the relay server;
the transmitter being configured to attempt to connect with said another terminal by making first to third connection attempts including:
a first connection attempt using the private address of said another terminal,
a second connection attempt using the public address of said another terminal, and
a third connection attempt using the address of the relay server; and
the first to third connection attempts being carried out using one of:
a concurrent manner, and
a sequential manner, at predetermined time intervals.

9. The terminal of claim 8, wherein the terminal connects with said another terminal through a given one of the first to third connection attempts before connecting with said another terminal through either of the others of the first to third connection attempts.
